(19) United States
(12) Patent Application Publication
(10) Pub. No.: US 2012/0051403 A1
(43) Pub. Date: Mar. 1, 2012

(54) METHOD AND APPARATUS FOR SUPPORTING COMMUNICATION SERVICE OF COMMUNICATION TERMINAL HAVING RELAY FUNCTION

(75) Inventors: Bu Seop JUNG, Suwon-si (KR); Hyun Soo KIM, Yongin-si (KR)

(73) Assignee: SAMSUNG ELECTRONICS CO. LTD., Suwon-si (KR)

(21) Appl. No.: 13/175,419

(22) Filed: Jul. 1, 2011

(30) Foreign Application Priority Data
Sep. 1, 2010 (KR) 10-2010-0085198

(51) Int. Cl. H04L 25/20

(52) U.S. Cl. 375/211

(57) ABSTRACT

An apparatus and method for supporting a communication service of a communication terminal having a relay function are provided. The method for supporting a communication service of a communication terminal includes verifying a current data transmission rate in a relay operation mode to determine a transmission power level of a down link, and relaying the communication service to the down link according to the transmission power level. The method and the apparatus for supporting the communication service of the communication terminal with the relay function may control transmission power such that the communication terminal may maintain data transmission rate with a suitable level.

### PRIORITY

This application claims the benefit under 35 U.S.C. §119(a) of a Korean patent application filed on Sep. 1, 2010 in the Korean Intellectual Property Office and assigned Serial No. 10-2010-0085198, the entire disclosure of which is hereby incorporated by reference.

### BACKGROUND OF THE INVENTION

1. Field of the Invention

The present invention relates to a communication method and an apparatus of a communication terminal in a communication system. More particularly, the present invention relates to a method for supporting a communication service of a communication terminal having a relay function, and an apparatus thereof.

2. Description of the Related Art

In general, a communication system has been developed for the purpose of providing communication while securing the mobility of a user. With recent technology developments, the communication system has developed to provide a speech communication service and a high-speed data communication service. Accordingly, a communication terminal in a communication system accesses the Internet to transmit or receive packet data thereto or therefrom. Further, a current communication system supports a tethering function. That is, the communication terminal in the communication system has a relay function to provide Internet access of a client. At this time, the communication terminal may receive the packet data from the Internet and provide the packet data to the client.

However, in the communication system as described above, because the communication terminal transmits packet data to the client with the highest transmission rate, power consumption occurs in the communication terminal. That is, a small battery is mounted in the communication terminal to secure mobility of the communication terminal and implement a miniaturized size. Accordingly, when there is a large amount of data to be transmitted to the client from the communication terminal or a plurality of clients access the communication terminal, power consumption may be significantly increased in the communication terminal. Due to the increased power consumption, it becomes difficult to efficiently control power in the communication terminal. This significantly deteriorates utilization of the communication terminal

### SUMMARY OF THE INVENTION

Aspects of the present invention are to address the above-mentioned problems and/or disadvantages and to provide at least the advantages described below. Accordingly, an aspect of the present invention is to provide a communication terminal that can maintain a data transmission rate with a suitable level.

In accordance with an aspect of the present invention, a method for supporting a communication service of a communication terminal having a relay function is provided. The method includes verifying a current data transmission rate in a relay operation mode to determine a transmission power level of a down link, and relaying the communication service to the down link according to the transmission power level.

In accordance with another aspect of the present invention, an apparatus for supporting a communication service of a communication terminal having a relay function is provided. The apparatus includes a relay processor for verifying a current data transmission rate in a relay operation mode to determine a transmission power level of a down link, and a relay communication unit for relaying the communication service to the down link according to the transmission power level under control of the relay processor.

Therefore, a method and an apparatus for supporting a communication service of a communication terminal with a relay function according to the present invention may control transmission power such that the communication terminal may maintain a data transmission rate with a suitable level. That is, the communication terminal may control transmission power according to a communication environment. Through this, a communication performance for executing a relay function in the communication terminal may be secured and power consumption in the communication terminal may be reduced. Further, the present invention may efficiently control power in the communication terminal to improve utilization of the communication terminal

Other aspects, advantages, and salient features of the invention will become apparent to those skilled in the art from the following detailed description, which, taken in conjunction with the annexed drawings, discloses exemplary embodiments of the present invention.

### BRIEF DESCRIPTION OF THE DRAWINGS

The objects, features, and advantages of the present invention will be more apparent from the following description taken in conjunction with the accompanying drawings, in which:

FIG. 1 is a view illustrating a communication system according to an exemplary embodiment of the present invention;

FIG. 2 is a block diagram illustrating a configuration of a communication terminal according to an exemplary embodiment of the present invention;

FIG. 3 is a flowchart illustrating a method for supporting a communication service of a communication terminal according to an exemplary embodiment of the present invention;

FIG. 4 is a flowchart illustrating a procedure for determining a transmission power level according to an exemplary embodiment of the present invention; and

FIG. 5 is a flowchart illustrating a procedure for determining a transmission power level according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

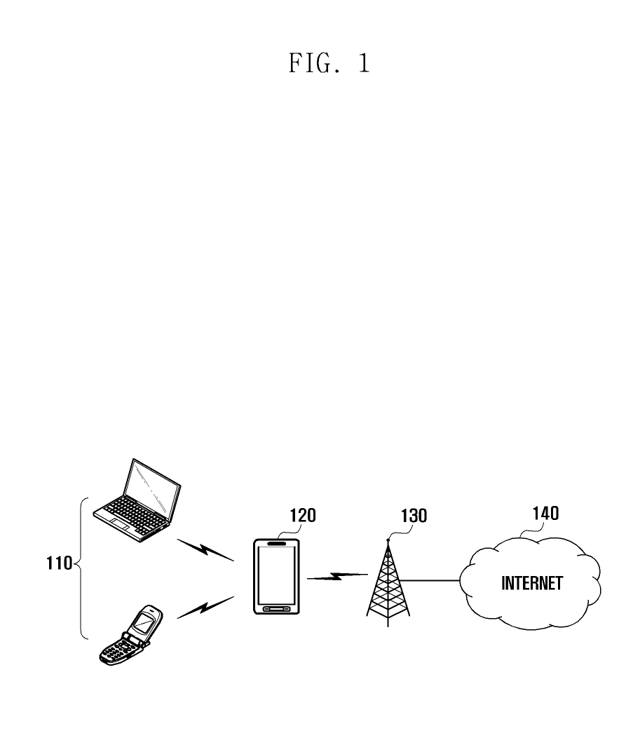

FIG. 1 is a view illustrating a communication system according to an exemplary embodiment of the present invention. In this case, the communication system supports a tethering function.

Referring to FIG. 1, the communication system includes at least one client terminal 110, a mobile access point 120, and a base station 130. In this case, the base station 130 accesses an Internet 140.

The client terminal 100 may access the mobile access point 120. In this case, the client terminal 110 may communicate with the mobile access point 120 through a near distance communication network. Here, the near communication network may be a Wireless Fidelity (Wi-Fi). For example, the client terminal 110 may be a notebook or a portable phone.

The mobile access point 120 supports access between the client terminal 110 and the Internet 140. That is, the mobile access point 120 relays a communication service between the client terminal 110 and the Internet 140. In this case, the mobile access point 120 may receive packet data of the Internet 140 and transfer the received packet data to the client terminal 110. Here, when the client terminal 110 is located within a preset distance from the mobile access point 120, the mobile access point 120 may communicate with the client terminal 110 through a near distance communication network. For example, the mobile access point 120 may be a portable phone.

The base station 130 connects with the Internet 140, and provides access between the mobile access point 120 and the Internet 140. That is, the base station 130 provides a communication service to the mobile access point 120. At this time, the base station 130 transmits packet data from the Internet 140 to the mobile access point 120. Here, the base station 130 may communicate with the mobile access point 130 through a 3^{rd} Generation (3G) mobile communication network.

In this case, a data transmission rate in the mobile communication network differs from that in the near distance communication network. That is, a Receiving (Rx) Data Rate and a Transmitting (Tx) Data Rate of a down link in the mobile access point 120 differ from each other. For example, when packet data is received from the base station 130 through the mobile communication network, the received data rate of the mobile access point 120 may be a maximum of 3.6 Mbps. When packet data is transmitted to the client terminal 110 through a near distance communication network, a data transmission rate of the mobile access point 120 may be a maximum of 27 Mbps. Here, the received data rate is determined according to a state, namely a communication environment of a mobile communication network. Further, the data transmission rate is determined according to a state, namely a communication environment of a near distance communication network. However, the data transmission rate of the mobile access point 120 should be higher than the received data rate. Moreover, the mobile access point 120 may control transmission power to maintain the data transmission rate with a suitable level.

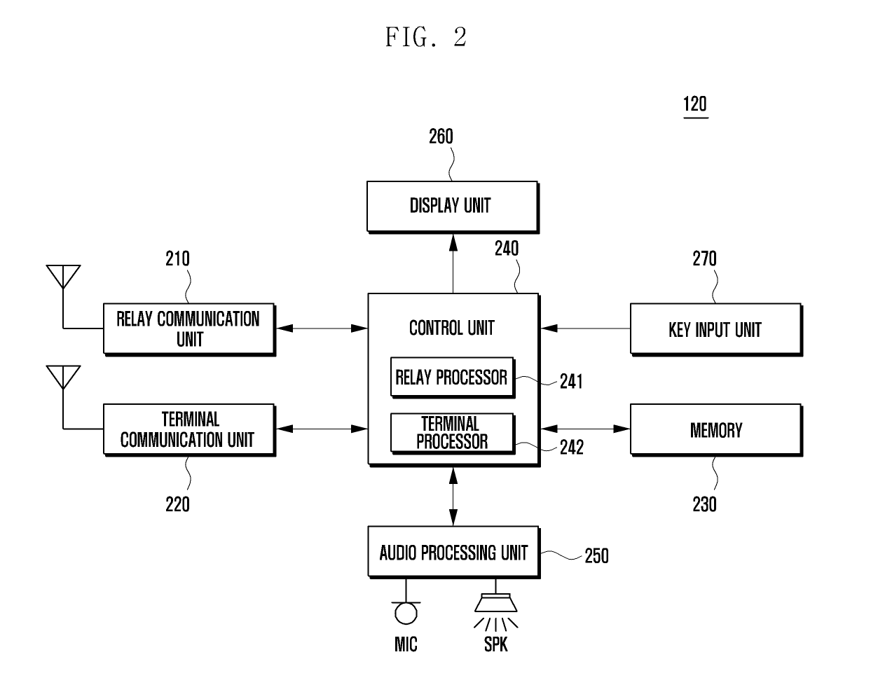

FIG. 2 is a block diagram illustrating a configuration of a communication terminal according to an exemplary embodiment of the present invention. In this case, a communication terminal is a mobile access point. It is assumed herein that the communication terminal is a portable phone. However, the present invention is not limited thereto.

Referring to FIG. 2, the mobile access point 120 includes a relay communication unit 210, a terminal communication unit 220, a memory unit 230, a control unit 240, an audio processing unit 250, a display unit 260, and a key input unit 270.

The relay communication unit 210 of the mobile access point 120 executes a communication function with a client terminal 110. The relay communication unit 210 includes a Radio Frequency (RF) transmitter (not illustrated) for up-converting a frequency of a transmitted signal through a near distance communication network and for amplifying the signal, and an RF receiver (not illustrated) for low-noise-amplifying a received signal and for down-converting the signal.

The terminal communication unit 220 of the mobile access point 120 executes a communication function with a base station 130. The terminal communication unit 220 includes an RF transmitter (not illustrated) for up-converting a frequency of a transmitted signal through a mobile communication network and for amplifying the signal, and an RF receiver (not illustrated) for low-noise-amplifying a received signal and for down-converting the signal.

The memory unit 230 may include a program memory (not illustrated) and a data memory (not illustrated). The program memory stores programs for controlling a general operation of the mobile access point 120. The program memory stores programs for controlling Transmission (Tx) power and executing a relay function according to an exemplary embodiment of the present invention. The data memory stores data during execution of the programs.

The control unit 140 executes a function controlling an overall operation of the mobile access point 120. The control unit 240 includes a data processor composed of a transmitter for encoding and modulating a transmitted signal and a receiver for demodulating and decoding a received signal. In this case, the data processor may be configured by a MODulator-DEModulator (MODEM) and a CODer-DECoder (CODEC). The CODEC includes a data CODEC for processing packet data and an audio CODEC for processing an audio signal such as speech. The control unit 240 includes a relay processor 241 and a terminal processor 242 according to an exemplary embodiment of the present invention.

The relay processor 241 executes a function of relaying a communication service for the client terminal 110 in a relay operation mode. In this case, the relay processor 241 processes and transmits packet data received from the relay communication unit 210 through the terminal communication unit 220. Here, the relay processor 241 may convert packet data according to a mobile communication network corresponding to a near distance communication network. Further, the relay processor 241 periodically verifies a data transmission rate to determine a Transmitting (Tx) power level according to an exemplary embodiment of the present invention. That is, the relay processor 241 determines and uses one of a plurality of power levels corresponding to a current data transmission rate as a transmission power level to relay a communication service.

The terminal processor 242 executes a function using a communication service for the mobile access point 120 in a terminal operation mode. At this time, the terminal processor 242 processes and stores or plays packet data received through the relay communication unit 210. Further, the terminal processor 242 may execute other additional functions.

The audio processing unit 250 executes a function playing an audio signal received from the audio CODEC of the data processor through a Speaker (SPK) or transmitting a transmission audio signal generated from the Microphone (MIC) to the audio CODEC of the data processor. The audio processing unit 250 may process an audio signal in a terminal operation mode.

The display unit 260 displays user data output from the control unit 240. The display unit 260 may use a Liquid Crystal Display (LCD). In this case, the display unit 260 may include an LCD controller, a memory storing image data, and an LCD display element. The display unit 260 may be implemented as a touch screen type display. In this case, the display unit 260 may display user data in a terminal operation mode. The input unit 270 may be configured by keys for inputting numeral and character information and function keys for setting various types of functions.

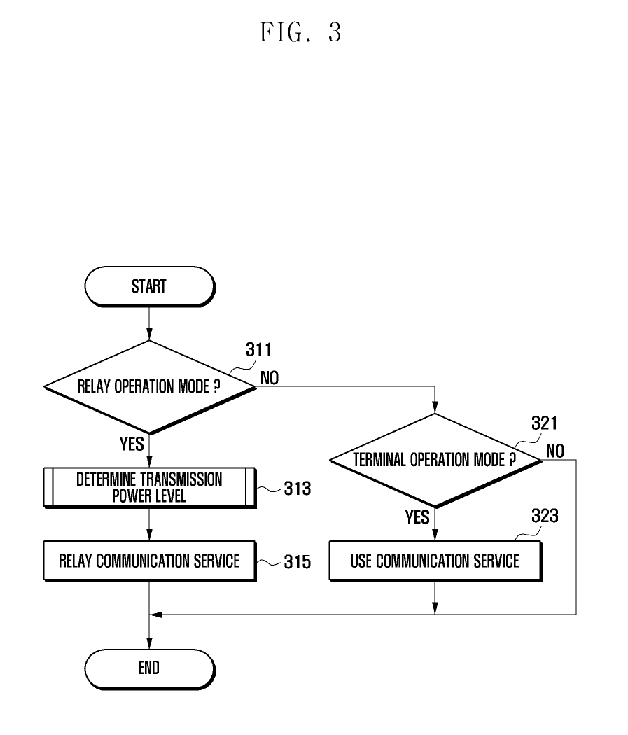

FIG. 3 is a flowchart illustrating a method for supporting a communication service of a communication terminal according to an exemplary embodiment of the present invention.

Referring to FIG. 3, a control unit 240 firstly executes a relay operation mode at step 311. The control unit 240 determines a transmission power level of a down link in the relay operation mode at step 313. At this time, the control unit 240 periodically verifies a data transmission rate to determine a transmission power level. That is, the control unit 240 adaptively changes a setting of the transmission power level according to a change in the data transmission rate in the terminal operation mode. Here, because the data transmission rate is determined according to a state of a near distance communication network, the control unit 240 may recognize a state of a near distance communication network based on the data transmission rate. Further, the control unit 240 may determine the transmission power level in consideration of the state of the near distance communication network.

Next, the control unit 240 relays a communication service to a down link according to the transmission power level at step 315. At this time, the control unit 240 controls transmission power according to the transmission power level to transmit packet data to a down link. That is, the control unit 240 processes and transmits packet data received through the relay communication unit 210 through the terminal communication unit 220.

Meanwhile, the control unit 240 may not execute the relay operation mode at step 311, but may execute a terminal operation mode at step 321. The control unit 240 uses a communication service in the terminal operation mode at step 323. At this time, the control unit 240 may process and store or play packet data received through the relay communication unit 210. Further, the control unit 240 may execute other additional functions.

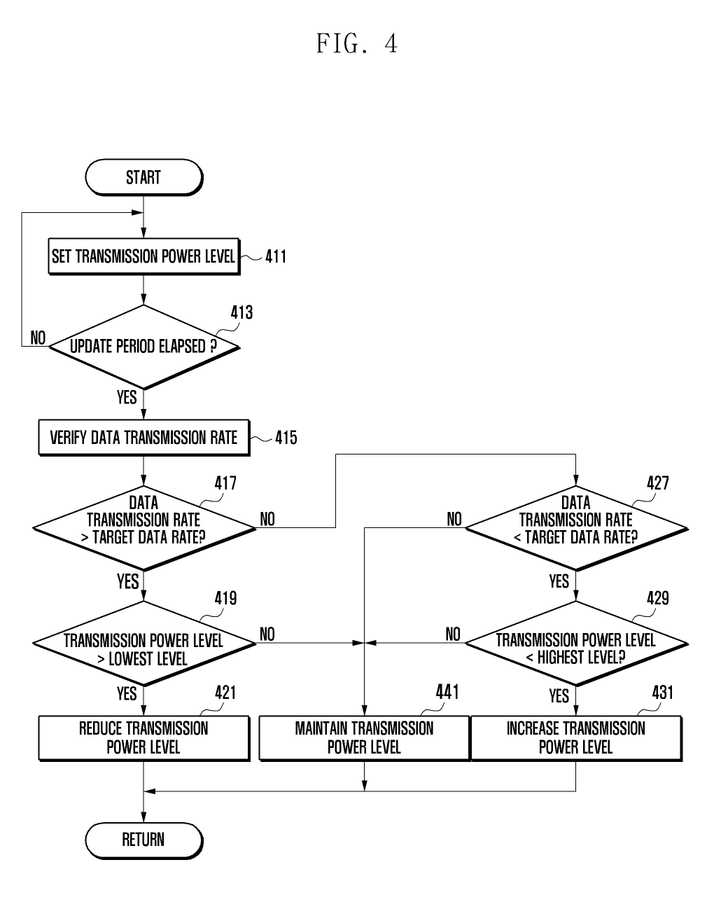

FIG. 4 is a flowchart illustrating a procedure for determining a transmission power level according to an exemplary embodiment of the present invention.

Referring to FIG. 4, a control unit 240 firstly sets a transmission power level at step 411. At this time, the control unit 240 sets one of a plurality of power levels. Here, the control unit 240 may set the highest power level among a plurality of power levels. Meanwhile, the control unit 240 may set one power level determined through a previous procedure of determining a transmission power level among the plurality of power levels.

Subsequently, if a set update period elapses, the control unit 240 detects the elapsed update period at step 413 and verifies a current data transmission rate at step 415. At this time, a data transmission rate of the mobile access point 120 is determined and used according to a set Rate Control Algorithm. For example, the Rate Control Algorithm may be an Automatic Rate Fallback (ARF). That is, when two continuous transmissions at a data transmission rate corresponding to a preset one of a plurality of rate levels fail, the relay terminal 120 decreases the data transmitting rate such that the current rate level corresponds to another rate level lower than the current rate level by one. Meanwhile, when two continuous transmissions at a data transmission rate corresponding to a preset one of a plurality of rate levels succeed, the relay terminal 120 increases the data transmitting rate such that the current rate level corresponds to another rate level higher than the current rate level by one.

Subsequently, the control unit 240 determines whether the data transmission rate exceeds a set target data rate at step 417. At this time, the target data rate is determined as a minimal value for securing a communication performance in a near distance communication network. Here, the target data rate may be a maximum value available as a received data rate in the mobile access point 120.

If the data transmission rate exceeds the target data rate at step 417, the control unit 240 determines whether the transmission power level exceeds the lowest minimal power level at step 419. That is, the control unit 240 determines whether reducing the transmission power level is possible. If the transmission power level exceeds the minimal power level at step 419, the control unit 240 reduces the transmission power level at step 421 and returns to FIG. 3. That is, if reducing the transmission power level is possible, the control unit 240 reduces and updates the transmission power level by one level. On the other hand, if the transmission power level does not exceed the minimal power level, the control unit 240 maintains the transmission power level at step 441, and returns to FIG. 3. That is, if the transmission power level is the lowest power level, the control unit 240 maintains the transmission power level.

On the other hand, if the data transmission rate does not exceed the target data rate at step 417, the control unit 240 determines whether the data transmission rate is lower than the target data rate at step 427. At this time, the target data rate is determined as a value for securing a communication performance to a minimum in a near distance communication network. Here, the target data rate may be a maximal value available for a received data rate in the mobile access point 120.

If the data transmission rate is lower than the target data rate at step 427, the control unit 240 determines whether the transmission power level is lower than the highest power level at step 429. That is, the control unit 240 determines whether increasing the transmission power level is possible. If the transmission power level is lower than the highest power level at step 429, the control unit 240 increases the transmission power level at step 431 and returns to FIG. 3. That is, if the increase of the transmission power level is possible, the control unit 240 increases and updates the transmission power level by one level. If the transmission power level is equal to or higher than the highest power level at step 429, the control unit 240 maintains the transmission power level at step 441 and returns to FIG. 3. That is, if the transmission power level is the highest power level, the control unit 240 maintains the transmission power level.

On the other hand, if the data transmission rate is equal to or higher than the target data rate at step 427, the control unit 240 maintains the transmission power level at step 441 and returns to FIG. 3. That is, if the data transmission rate is identical with the target data rate, the control unit 240 maintains the transmission power level.

In the meantime, the foregoing exemplary embodiment of the present invention has illustrated that the control unit 240 compares a current data transmission rate with a set target data rate to control the transmission power level by way of example. However, the present invention is not limited thereto. That is, the control unit 240 may flexibly determine a target data rate and compare a current data transmission rate with a current target data rate to control the transmission power level. At this time, since a data transmission rate of the mobile access point 120 should be equal to or higher than a received data rate, the control unit 240 may determine the received data rate as the target data rate. As a result, the control unit 240 may flexibly determine a target data rate according to a state of a mobile communication network, which is described in more detail below.

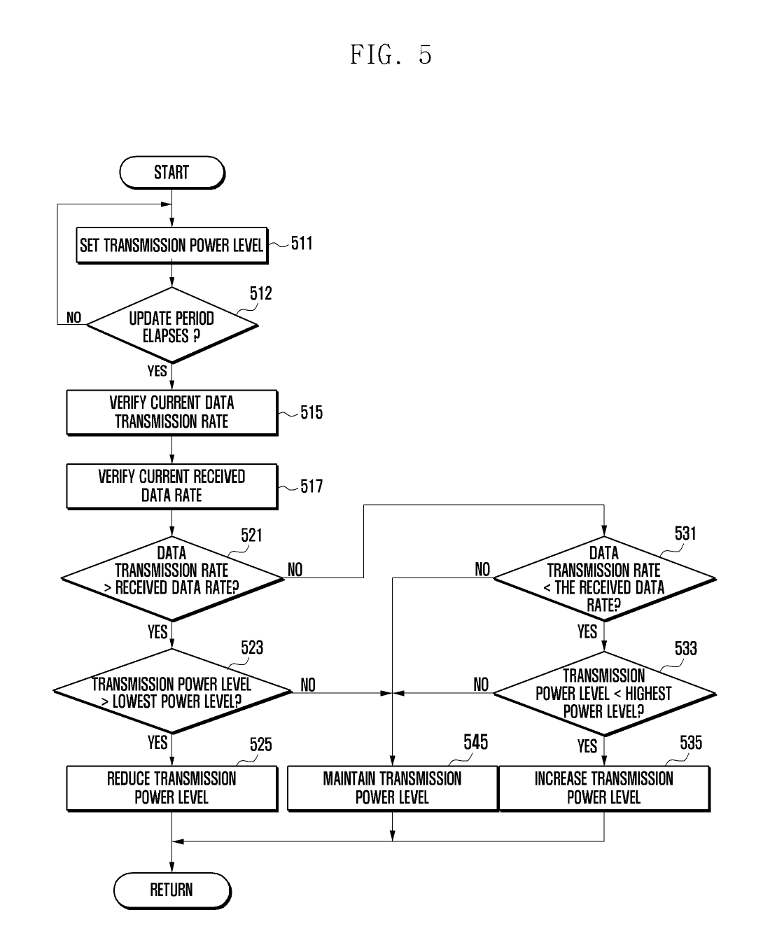

FIG. 5 is a flowchart illustrating a procedure for determining a transmission power level according to an exemplary embodiment of the present invention.

Referring to FIG. 5, the control unit 240 firstly sets a transmission power level at step 511. At this time, the control unit 240 set one of a plurality of power levels. Here, the control unit 240 may set the highest power level among the plurality of power levels. The control unit 240 may set one power level determined in a previous procedure for determining the transmission power level among the plurality of power levels.

Next, a control unit 240 determines whether a set update period elapses at step 512. When the set update period elapses, the control unit 240 verifies a current data transmission rate at step 515. At this time, a data transmission rate of the mobile access point 120 is determined and used according to a set rate control algorithm. For example, the Rate Control Algorithm may be an ARF. That is, when two continuous transmissions at a data transmission rate corresponding to a preset one of a plurality of rate levels fail, the relay terminal 120 decreases the data transmitting rate such that the current rate level corresponds to another rate level lower than the current rate level by one. Meanwhile, when two continuous transmissions at a data transmission rate corresponding to a preset one of a plurality of rate levels succeed, the relay terminal 120 increases the data transmitting rate such that the current rate level corresponds to another rate level higher than the current rate level by one. The control unit 240 verifies a current received data rate at step 517.

Subsequently, the control unit 240 determines whether the data transmission rate exceeds a received data rate at step 521. At this time, the received data rate is regarded as a value for securing a communication performance to a minimum in the near distance communication network. Here, the received data rate may be lower than or equal to a maximum value available for the received data rate in the mobile access point 120.

If the data transmission rate exceeds the received data rate at step 521, the control unit 240 determines whether a transmission power level exceeds the lowest power level at step 523. That is, the control unit 240 determines whether reducing the transmission power level is possible. If the transmission power level exceeds the lowest power level at step 523, the control unit 240 reduces the transmission power level at step 525, and returns to FIG. 3. That is, if reduction of the transmission power level is possible, the control unit 240 reduces and updates the transmission power level by one level. If the transmission power level is lower than or equal to the lowest power level at step 523, the control unit 240 maintains the transmission power level at step 545, and returns to FIG. 3. That is, if the transmission power level corresponds to the lowest power level, the control unit 240 maintains the transmission power level.

On the other hand, if the data transmission rate is lower than or equal to the received data rate, the control unit 240 determines whether the data transmission rate is lower than the received data rate at step 531. At this time, the received data rate is regarded as a value for securing a communication performance to a minimum in the near distance communication network. Here, the received data rate may be lower than or equal to a maximum value available for the received data rate in the mobile access point 120.

If the data transmission rate is lower than the received data rate, the control unit 240 determines whether the transmission power level is lower than the highest power level at step 533. That is, the control unit 240 determines whether increasing the transmission power level is possible. If the transmission power level is lower than the highest power level at step 533, the control unit 240 increases the transmission power level at step 535, and returns to FIG. 3. That is, if the increase of the transmission power level is possible, the control unit 240 increases and updates the transmission power level by one level. If the transmission power level exceeds the highest power level, the control unit 240 maintains the transmission power at step 545, and returns to FIG. 3. That is, if the transmission power level corresponds to the highest power level, the control unit 240 maintains the transmission power level.

On the other hand, if the data transmission rate is equal to or higher than the received data rate at step 531, the control unit 140 maintains the transmission power level, and returns to FIG. 3. That is, if the data transmission rate is identical with the received data rate, the control unit 240 maintains the transmission power level.

The foregoing exemplary embodiment of the present invention has illustrated that the control unit 240 may control the transmission power level by distinguishing situations in which the data transmission rate exceeds, is lower than, or is identical with the target data rate. However, the present invention is not limited thereto. That is, the control unit 240 may control the transmission power level by distinguishing situations in which the data transmission rate is equal to or higher than and is lower than the target data rate.

Exemplary embodiments of the present invention may control transmission power such that the data transmission rate in the mobile access point may be maintained at a suitable level. That is, the mobile access point may control transmission power according to a communication environment. Accordingly, exemplary embodiments of the present invention may secure a communication performance for executing a relay function in the mobile access point and reduce power consumption of the mobile access point. Therefore, power in the mobile access point may be efficiently controlled to improve utilization of the mobile access point.

While this invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for supporting a communication service of a communication terminal, the method comprising:
verifying a current data transmission rate in a relay operation mode to determine a transmission power level of a down link; and
relaying the communication service to the down link according to the transmission power level.

2. The method of claim 1, wherein the verifying of the current data transmission rate comprises:
verifying the data transmission rate when an update period elapses; and
determining the transmission power level as a level lower than a set level when the data transmission rate exceeds a target data rate.

3. The method of claim 2, wherein the verifying of the current data transmission rate comprises determining the power level as a level higher than the set level when the data transmission rate is lower than the target data rate.

4. The method of claim 2, wherein the verifying of the current data transmission rate comprises verifying a received data rate to apply to the target data rate.

5. The method of claim 2, wherein the verifying of the current data transmission rate comprises maintaining the transmission power level as the set level when the data transmission rate is identical with the target data rate.

6. The method of claim 2, wherein the verifying of the current data transmission rate comprises updating the set level as the determined power level.

7. An apparatus for supporting a communication service of a communication terminal, the apparatus comprising:
a relay processor for verifying a current data transmission rate in a relay operation mode to determine a transmission power level of a down link; and
a relay communication unit for relaying the communication service to the down link according to the transmission power level under control of the relay processor.

8. The apparatus of claim 7, wherein the relay processor verifies the data transmission rate when an update period elapses, and determines the transmission power level as a level lower than a set level when the data transmission rate exceeds a target data rate.

9. The apparatus of claim 8, wherein the relay processor determines the power level as a level higher than the set level when the data transmission rate is lower than the target data rate.

10. The apparatus of claim 8, wherein the relay processor verifies a received data rate to apply to the target data rate.

11. The apparatus of claim 8, wherein the relay processor maintains the transmission power level as the set level when the data transmission rate is identical with the target data rate.

12. The apparatus of claim 8, wherein the relay processor updates the set level as the determined power level.
